(19) United States
(12) Patent Application Publication
(10) Pub. No.: US 2015/0198417 A1
(43) Pub. Date: Jul. 16, 2015

(54) ILLUMINATOR FOR A PISTOL

(71) Applicant: Theodore J. Werner, Huntington Station, NY (US)

(72) Inventor: Theodore J. Werner, Huntington Station, NY (US)

(21) Appl. No.: 14/155,664

(22) Filed: Jan. 15, 2014

(51) Int. Cl. F41G 1/35; F21L 4/04; F21V 33/00; F21L 4/00

(52) U.S. Cl. CPC F41G 1/35; F21L 4/00; F21L 4/04; F21V 33/008; F21W 2111/10

(57) ABSTRACT

An illuminator that attaches to a pistol having a grip and a barrel with a top and a side, and illuminates forwardly. The illuminator includes a bracket, a light housing, and a light. The bracket interchangeably mounts to the pistol. The light housing extends from the bracket. The light is disposed within the light housing and illuminates forwardly. In one embodiment, the light housing is attached to the side of the barrel of the pistol. In another embodiment, the light housing is attached to the top of the barrel of the pistol. In still another embodiment, the light housing is attached to the grip of the pistol.

### 1. CROSS REFERENCE TO RELATED APPLICATIONS

The instant non-provisional patent application claims priority from provisional patent application No. 61/850,231, filed on Feb. 11, 2013, for a LED LIGHT FOR A PISTOL, and incorporated in its entirety herein by reference thereto.

### 2. BACKGROUND OF THE INVENTION

A. Field of the Invention

The embodiments of the present invention relate to an illuminator for a pistol, and more particularly, the embodiments of the present invention relate to an illuminator for attaching to a pistol having a grip and a barrel with a top and a side, and for interchangeably mounting to either the grip of the pistol, the top of the barrel of the pistol, or the side of the barrel of the pistol, and illuminating forwardly.

B. Description of the Prior Art

Numerous innovations for illuminating devices for firearms have been provided in the prior art, which will be described below in chronological order to show advancement in the art, and which are incorporated herein in their entirety by reference thereto. Even though these innovations may be suitable for the specific individual purposes to which they address, nevertheless, they differ from the embodiments of the present invention in that they do not teach an illuminator for attaching to a pistol having a grip and a barrel with a top and a side, and for interchangeably mounting to either the grip of the pistol, the top of the barrel of the pistol, or the side of the barrel of the pistol, and illuminating forwardly.

(1) English Patent Application Publication Number 28,924 to Gesellschaft et al.

English Patent Application Publication Number 28,924—published to Gesellschaft et al. on Dec. 16, 1913—teaches a luminous sight tube. The distinguishing feature being that, either with or without the source of electricity arranged in the tube. The source of electricity can be arranged interchangeably on the outside of the tube or be put directly and interchangeably thereon by way of a contact plug or be connected therewith by way of suitable exchangeable contacts and a corresponding connection cord.

(2) English Patent Application Publication Number 167,989 to Weiss.

English Patent Application Publication Number 167,989—published to Weiss on Aug. 25, 1921—teaches a flashlight attachment for firearms, which includes a plate having a concave surface and curved arms extending upward and toward each other. The arms and the plate together constitute an element having a circular cross section for intimately engaging a cylindrical object. Apparatus secures the approaching ends of the arms. A resilient annular member constitutes a split ring, and includes laterally extending elements for connection with the plate on the side opposite to the curved side thereof.

(3) U.S. Pat. No. 2,450,584 to Dodge.

U.S. Pat. No. 2,450,584—issued to Dodge on Oct. 5, 1948 in U.S. class 240 and subclass 6.41—teaches an attachment for securing a flashlight to a gun, an L-shaped frame having an upwardly extended forward end, a clamp for securing the upwardly extending forward end to the trigger guard of the gun, and the other end of the frame is secured to the stock of the gun. A separable band is secured to the L-shaped frame, intermediate the ends of the frame. The band is secured to the flashlight. A forward supporting member is adjustably mounted on the upwardly extended end of the frame. The forward member has an arcuate-shaped edge engaging the curved edge of the flashlight. A supporting member, at the rear end of the frame, engages the flashlight. The supporting members hold the flashlight against lateral movement when the gun is aimed. A switch is on the gun. Electrical connections are between the switch and the flashlight whereby the flashlight is operated illuminating the target at which the gun is pointed.

(4) U.S. Pat. No. 4,348,716 to Storm et al.

U.S. Pat. No. 4,348,716—issued to Storm et al. on Sep. 7, 1982 in U.S. class 362 and subclass 188—teaches a flashlight holder for attachment to a pistol. The holder positions the flashlight on the pistol whereby the flashlight is horizontally and vertically adjusted so that its light beam falls directly upon the object at which the gun is aimed.

(5) U.S. Pat. No. 4,777,754 to Reynolds, Jr.

U.S. Pat. No. 4,777,754—issued to Reynolds, Jr. on Oct. 18, 1988 in U.S. class 42 and subclass 103—teaches an aim assistance light beam for a firearm having functional parts necessary for the operation of the firearm. The firearm is provided by adaption of a battery housing to a contour of the firearm below a barrel and ahead of a trigger guard thereof as seen in a direction of the light beam for reception of an electric battery remotely from a stock of the firearm. A common fastener is for the battery housing, as well as for one of the necessary functional parts of the firearm. Both the battery housing and the one necessary functional part are attached with the common fastener to the firearm. A light source is mounted on the battery housing for providing an aim assistance light beam upon energization from the battery through an electric on-off switch provided independently of any trigger and hammer assembly of the firearm.

(6) U.S. Pat. No. 5,560,703 to Capps, III.

U.S. Pat. No. 5,560,703—issued to Capps, III on Oct. 1, 1996 in U.S. class 362 and subclass 110—teaches a mounting device for mounting a flashlight on a handgun, which has a first bracket for attachment to the grip of the handgun. The first bracket is contoured to the surface of the handgun grip, and is engageable with the grip by friction. The first bracket that engages the grip, extends partially around the grip, and is further urged against the grip by way of an elastic band. The first bracket is connected to a second bracket that holds a flashlight in a desired alignment for coinciding with the barrel of the gun. The second bracket is located away from the grasping surface, except for an upper region that is welded flush to the first bracket so as to not interfere with a normal gripping of the gun.

(7) U.S. Pat. No. 6,023,875 to Fell et al.

U.S. Pat. No. 6,023,875—issued to Fell et al. on Feb. 15, 2000 in U.S. class 42 and subclass 103—teaches a lightweight illumination source and illumination mount system including an illumination device that is a small flashlight or laser, and a mount that is detachably secured to a family of firearms, namely, pistols, revolvers, and long guns. The illuminating system, including the flashlight and the mount, is attached to the base of a pistol grip by removing the floor plate from the pistol's magazine and installing the mount in place of the original magazine floor plate. The magazine's spring seat insert locks the mount in place. Another variation is mounted to the butt of a revolver. The resulting system provides the user the capability to simultaneously activate the illuminating device, while using a standard two handed grip on the firearm, and if the need arises, the capability to operate both the light and the gun with one hand, while performing other tasks, such as finding a light switch, making a phone call, etc. With the mount attached to the grip or butt of the weapon, the firearm is stored in any standard holster when not in use. Changing magazines restores a pistol to its factory-original condition without leaving a trace that an illuminating system was ever mounted to the gun. The mount may also be configured to support any laser having a ½″ diameter. Another variation of the mount is secured to the barrel of any long gun, such as a 12 gauge shotgun, or any other device, such as, but not limited to, binoculars, scopes, etc., that may have a ¾″ to 1 ¼″ diameter. The flashlight has either a remote pressure switch that is secured to the firearm by hook and loop VELCRO® fasteners, or a turn/push switch configuration. The flashlight is also used independently from the firearms mounting systems. The mount also accepts any flashlight the user has that is 1″ in diameter.

(8) U.S. Pat. No. 6,378,237 to Matthews et al.

U.S. Pat. No. 6,378,237—issued to Matthews et al. on Apr. 30, 2002 in U.S. class 42 and subclass 124—teaches an apparatus for firing projectiles at targets and for illuminating the targets from a combined projectile-firing weapon and target illuminator. A track-and-slide combination includes a slide on the target illuminator and a track structure on the weapon for the slide, and a releasable slide-in-track stop in the rack-and-slide combination. In the case of a firearm that has a trigger actuated by a bent trigger finger of a shooter for the firing thereof, a push-button or transverse slide switch for the target illuminator is mounted within reach of a pad of the trigger finger prior to actuation of the trigger. For example, the shooter draws the firearm with his or her trigger finger then outstretched for actuation of the target illuminator switch, and then bends the trigger finger for firing of the weapon by actuation of the trigger. This and other appliances have a battery compartment and a contact plate interconnecting batteries in the compartment. A contact plate retainer is coupled to the contact plate, and a contact plate retainer receptacle is provided therefor in the battery compartment.

(9) United States Patent Application Publication Number 2003/0090894 to Cummings.

United States Patent Application Publication Number 2003/0090894—published to Cummings on May 15, 2003 in U.S. class 362 and subclass 110—teaches a device to allow a commercially available flashlight to be mounted on, or in, the forward end of a firearm's magazine, thereby configuring a source of illumination in precise alignment with the bore of the gun. The device requires no modification to the gun in general, or magazine in particular, and consumes the space taken by a single shell allowing the remainder of the magazine to hold shells. The preferred embodiment permits certain types of barreled flashlights, such as the MAGLIGHT®, the SMITH & WESSON®, or the DORCY®, having a diameter on the order of 7/10″ to be mounted on, or into, the forward end of the magazine through the use of an adapter base module. To position the non-illuminating end of the flashlight in alignment relative to the spring present in the magazine, an optional spring guide in used.

(10) U.S. Pat. No. 6,574,901 to Solinsky et al.

U.S. Pat. No. 6,574,901—issued to Solinsky et al. on Jun. 10, 2003 in U.S. class 42 and subclass 146 teaches an attachment system for attaching an auxiliary apparatus to a weapon having a frame, and in particular, to a weapon frame in the area forward of the trigger guard. An attachment mechanism on the auxiliary apparatus is adapted to be engageable with a rail on the weapon to selectively attach the auxiliary apparatus. The weapon includes a transverse slot that is engaged by a portion of the auxiliary apparatus to prevent the auxiliary apparatus from sliding relative to the weapon due to recoil forces associated with firing the weapon.

(11) International Publication Number WO 2008/088362 to Rogers.

International Publication Number WO 2008/088362—published to Rogers on Jul. 24, 2008—teaches an adjustable and removable rail light mount for attachment to a firearm having a mounting rail. The mount includes a rail mount attached to a rail and a light carrier rotatably attached to the rail mount to position a light to the left or the right of a firearm by way of an axle carried by the rail mount. The axle fits through the rail mount and the light carrier. Passageways in the rail mount and the light carrier for the axle include grooves that engage detent bosses on the axle to maintain the light carrier in a selected location. The light carrier is removable when it is rotated to a centered downward position. A belt clip is attached to the removable light carrier.

It is apparent that numerous innovations for illuminating devices for firearms have been provided in the prior art, which are adapted to be used. Furthermore, even though these innovations may be suitable for the specific individual purposes to which they address, nevertheless, they would not be suitable for the purposes of the embodiments of the present invention as heretofore described, namely, an illuminator for attaching to a pistol having a grip and a barrel with a top and a side, and for interchangeably mounting to either the grip of the pistol, the top of the barrel of the pistol, or the side of the barrel of the pistol, and illuminating forwardly.

### 3. SUMMARY OF THE INVENTION

Thus, an object of the embodiments of the present invention is to provide an illuminator for attaching to a pistol having a grip and a barrel with a top and a side, and for interchangeably mounting to either the grip of the pistol, the top of the barrel of the pistol, or the side of the barrel of the pistol, and illuminating forwardly, which avoids the disadvantages of the prior art.

Briefly stated, another object of the embodiments of the present invention is to provide an illuminator for attaching to a pistol having a grip and a barrel with a top and a side, and illuminating forwardly. The illuminator includes a bracket, a light housing, and a light. The bracket interchangeably mounts to the pistol. The light housing extends from the bracket. The light is disposed within the light housing and illuminates forwardly. In one embodiment, the light housing is attached to the side of the barrel of the pistol. In another embodiment, the light housing is attached to the top of the barrel of the pistol. In still another embodiment, the light housing is attached to the grip of the pistol.

The embodiments of the present invention themselves, however, both as to their construction and to their method of operation together with additional objects and advantages thereof will be best understood from the following description of the embodiments of the present invention when read and understood in connection with the accompanying figures of the drawing.

### 4. BRIEF DESCRIPTION OF THE FIGURES OF THE DRAWING

The figures of the drawing are briefly described as follows:

FIG. 1 is a diagrammatic side elevational view of the illuminator of the embodiments of the present invention attached to the side of the barrel of a pistol and illuminating forwardly;

FIG. 2 is an enlarged diagrammatic cross sectional view taken along LINE 2-2 in FIGS. 1, 3, and 4;

FIG. 3 is a diagrammatic side elevational view of the illuminator of the embodiments of the present invention attached to the top of the barrel of a pistol and illuminating forwardly; and

FIG. 4 is a diagrammatic side elevational view of the illuminator of the embodiments of the present invention attached to the grip of a pistol and illuminating forwardly.

### 5. LIST OF REFERENCE NUMERALS UTILIZED IN THE FIGURES OF THE DRAWING

### A. Introductory

10 illuminator of embodiments of present invention for attaching to pistol 12 having grip 14 and barrel 18 with top 18a and side 18b
12 pistol
14 grip of pistol 12
18 barrel
18a top of barrel 18
18b side of barrel 18

### B. Specific Configuration of First Embodiment of Illuminator 10

20 bracket for forming part of grip 14 of pistol 12 and for also interchangeably positioning to side 18b of barrel 18 of pistol 12
22 light housing
24 light
26 battery interface for positioning within grip 14 of pistol 12 and for electrically receiving battery 28 for powering light 24
28 battery for powering light 24
30 pressure sensitive switch for extending forwardly from grip 14 of pistol 12

### C. Specific Configuration of Second Embodiment of Illuminator 210

210 illuminator
212 pistol
218 barrel of pistol 212
218a top of barrel 218 of pistol 212
220 bracket
222 light housing

### D. Specific Configuration of Third Embodiment of the Illuminator 310

310 illuminator
312 pistol
314 grip of pistol 312
320 bracket
322 light housing

### 6. DETAILED DESCRIPTION OF THE PREFERRED EMBODIMENTS

### A. Introductory

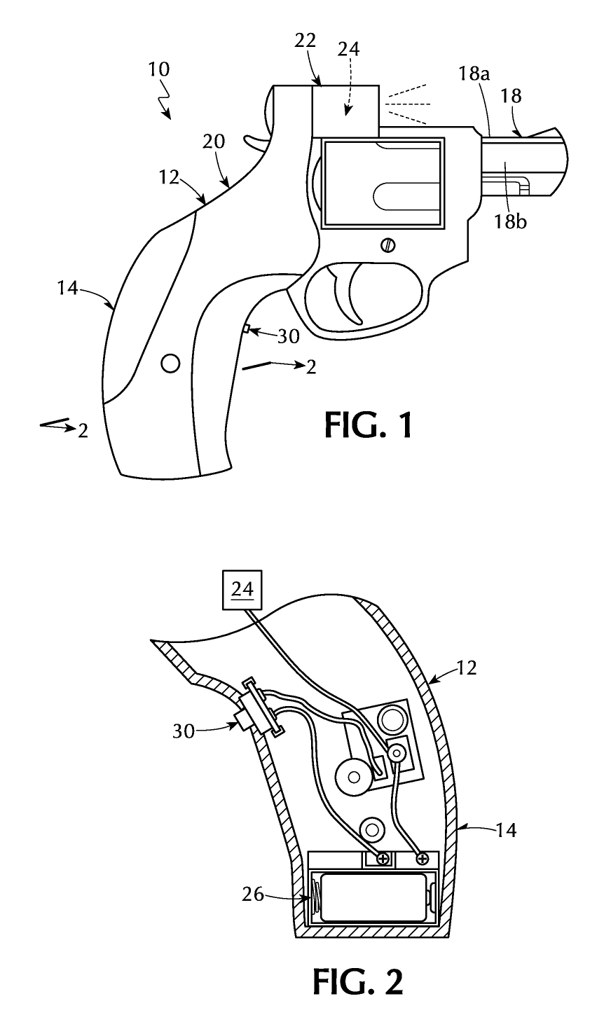

Referring now to the figures, in which like numerals indicate like parts, and particularly to FIG. 1, the illuminator of the embodiments of the present invention is shown generally at 10 for attaching to a pistol 12 having a grip 14 and a barrel 18 with a top 18a and a side 18b, and for interchangeably mounting to the pistol 12, and illuminating forwardly.

### B. Overall Configuration of the Illuminator 10

The overall configuration of the illuminator 10 can best be seen in FIGS. 1 and 2, and as such, will be discussed with reference thereto.

As shown in FIG. 1, the illuminator 10 comprises a bracket 20, a light housing 22, and a light 24. The bracket 20 is for interchangeably mounting to the pistol 12. The light housing 22 extends from the bracket 20. The light 24 is disposed within the light housing 22, and illuminates forwardly.

As shown in FIG. 2, the illuminator further comprises a battery interface 26.

The battery interface 26 is in electrical communication with the light 24, is for positioning within the grip 14 of the pistol 12, and is for electrically receiving a battery 28 for powering the light 24.

The illuminator 10 further comprises a pressure sensitive switch 30.

The pressure sensitive switch 30 is in electrical communication with the battery interface 26 and the light 24 so when the pressure sensitive switch 30 is pressed, the light 24 illuminates forwardly.

The pressure sensitive switch 30 is for extending forwardly from the grip 14 of the pistol 12.

The light 24 is, preferably, an LED that is, preferably, white, but could also be ultra violet, red, blue, a black light used in conjunction with special goggles for seeing targeted animals and humans without the targeted animals or humans seeing the light 24, stroboscopic light for terrifying targeted animals or people, a laser, etc. without departing in any way from the spirit of the embodiments of the present invention.

Depending upon the pistol 12, the battery 28 can be either a cylindrical battery or a button cell.

The bracket 20 is either ABS plastic with thermo plastic rubber or a similar material for surfaces that need to be soft, or a die cast frame, as needed for a heat sink for the light 24, with thermo plastic rubber inserts for cushions.

The light housing 22 is, preferably, cylindrically shaped, but is not limited to that.

The bracket 20 interchangeably mounts to form a portion of the grip 14 of the pistol 12.

### C. Specific Configuration of a First Embodiment of the Illuminator 10

The specific configuration of a first embodiment of the illuminator 10 can best be seen in FIG. 1, and as such, will be discussed with reference thereto.

The bracket 20 is also positioned on the side 18b of the barrel 18 of the pistol 12 for attaching the light housing 22 to the side 18b of the barrel 18 of the pistol 12.

### D. Specific Configuration of a Second Embodiment of the Illuminator 210

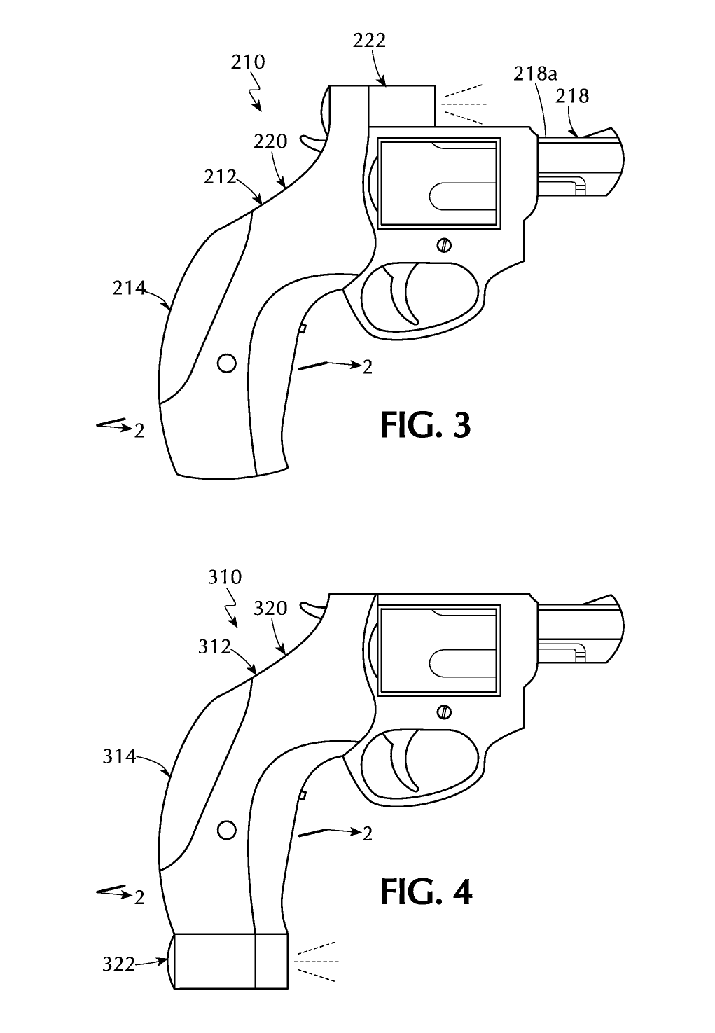

The specific configuration of a second embodiment of the illuminator 210 can best be seen in FIG. 3, and as such, will be discussed with reference thereto.

The illuminator 210 is similar to the illuminator 10, except that the bracket 220 is also positioned on the top 218a of the barrel 218 of the pistol 212 for attaching the light housing 222 to the top 218a of the barrel 218 of the pistol 212.

### E. Specific Configuration of a Third Embodiment of the Illuminator 310

The specific configuration of a third embodiment of the illuminator 310 can best be seen in FIG. 4, and as such, will be discussed with reference thereto.

The illuminator 310 is similar to the illuminator 10, except that the bracket 320 is also positioned on the grip 314 of the pistol 312 for attaching the light housing 322 to the grip 314 of the pistol 312.

### F. Impressions

It will be understood that each of the elements described above or two or more together may also find a useful application in other types of constructions differing from the types described above.

While the embodiments of the present invention have been illustrated and described as embodied in an illuminator for attaching to a pistol having a grip and a barrel with a top and a side, and for interchangeably mounting to either the grip of the pistol, the top of the barrel of the pistol, or the side of the barrel of the pistol, and illuminating forwardly, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. An illuminator for attaching to a pistol having a grip and a barrel with a top and a side, and illuminating forwardly, comprising:
a) a bracket;
b) a light housing; and
c) a light;
wherein said bracket is for interchangeably mounting to the pistol;
wherein said light housing extends from said bracket;
wherein said light is disposed within said light housing; and
wherein said light illuminates forwardly.

2. The illuminator of claim 1, further comprising a battery interface.

3. The illuminator of claim 2, wherein said battery interface is for positioning within the grip of the pistol.

4. The illuminator of claim 2, wherein said battery interface is for electrically receiving a battery for powering said light.

5. The illuminator of claim 2, wherein said battery interface is in electrical communication with said light.

6. The illuminator of claim 1, further comprising a pressure sensitive switch.

7. The illuminator of claim 6, wherein said pressure sensitive switch is for extending forwardly from the grip of the pistol.

8. The illuminator of claim 6, wherein said pressure sensitive switch is in electrical communication with said battery interface and said light so when said pressure sensitive switch is pressed, said light illuminates forwardly.

9. The illuminator of claim 1, wherein said light is an LED.

10. The illuminator of claim 1, wherein said light is an ultra violet light.

11. The illuminator of claim 1, wherein said light is a stroboscopic light; and
wherein said stroboscopic light of said light is for terrifying targeted animals or people.

12. The illuminator of claim 1, wherein said light is a black light; and
wherein said black light of said light is used in conjunction with special goggles for seeing targeted animals and humans without the targeted animals or humans seeing the light.

13. The illuminator of claim 1, wherein said bracket is ABS plastic with thermo plastic rubber for surfaces that need to be soft.

14. The illuminator of claim 1, wherein said bracket is a die cast frame for a heat sink for said light, with thermo plastic rubber inserts for cushions.

15. The illuminator of claim 1, wherein said light housing is cylindrically shaped.

16. The illuminator of claim 1, wherein said bracket interchangeably mounts to form a portion of the grip of the pistol.

17. The illuminator of claim 16, wherein said bracket is also for positioning on the side of the barrel of the pistol for attaching said light housing to the side of the barrel of the pistol.

18. The illuminator of claim 16, wherein said bracket is also for positioning on the top of the barrel of the pistol for attaching said light housing to the top of the barrel of the pistol.

19. The illuminator of claim 16, wherein said bracket is also for positioning on the grip of the pistol for attaching said light housing to the grip of the pistol.

20. The illuminator of claim 1, wherein said light is a laser.
